(19) United States
(12) Patent Application Publication
(10) Pub. No.: US 2026/0260944 A1
(43) Pub. Date: Sep. 3, 2026

(54) SECONDARY BATTERY AND ELECTRIC APPARATUS

(71) Applicant: CONTEMPORARY AMPEREX TECHNOLOGY CO., LIMITED, Ningde (CN)

(72) Inventors: Jie Guo, Ningde (CN); Zeli Wu, Ningde (CN); Changlong Han, Ningde (CN); Cuiping Zhang, Ningde (CN); Guan Wang, Ningde (CN)

(21) Appl. No.: 19/654,507

(22) Filed: Apr. 22, 2026

Related U.S. Application Data
(63) Continuation of application No. PCT/CN2025/076836, filed on Feb. 11, 2025.

(30) Foreign Application Priority Data
Mar. 22, 2024 (CN) 202410338592.1

(51) Int. Cl. H01M 10/0568; B60L 50/64; B60R 16/033; H01M 4/02; H01M 4/58; H01M 10/0567; H01M 10/0569

(52) U.S. Cl. CPC H01M 10/0568; H01M 4/5825; H01M 10/0567; H01M 10/0569; B60L 50/64; B60R 16/033; H01M 2004/021; H01M 2004/028; H01M 2220/20; H01M 2300/0037

(57) ABSTRACT

The present application provides a secondary battery and an electric apparatus. The secondary battery includes a positive electrode plate, a negative electrode plate, and an electrolyte. The positive electrode plate includes a lithium-containing transition metal phosphate, where the lithium-containing transition metal phosphate includes submicron-scale and micron-scale particles. In addition, the electrolyte in the secondary battery includes a lithium salt and a film-forming stabilizer, where the lithium salt includes a first lithium salt and a second lithium salt; where the first lithium salt includes lithium hexafluorophosphate, and the second lithium salt includes one or both of lithium bis(fluorosulfonyl)imide and lithium bis(trifluoromethanesulfonyl)imide. The secondary battery designed in the present application is conducive to balancing the energy density, rate performance, and cycling performance of the battery.

### CROSS-REFERENCE TO RELATED APPLICATIONS

The present application is a continuation of International Application No. PCT/CN2025/076836, filed on Feb. 11, 2025, which claims priority to Chinese Patent Application No. 2024103385921, filed on Mar. 22, 2024 and entitled “SECONDARY BATTERY AND ELECTRIC APPARATUS”, which is incorporated herein by reference in its entirety.

### TECHNICAL FIELD

The present application relates to the field of batteries, and specifically relates to a secondary battery and an electric apparatus.

### BACKGROUND

Secondary batteries are widely used in various consumer electronic products and electric vehicles due to their outstanding characteristics such as light weight, no pollution, and no memory effect, where lithium-ion batteries have very extensive applications in portable electronic devices, electric vehicles, and other fields.

As the application range of secondary batteries continues to expand, the requirements for their performance are becoming increasingly stringent.

### SUMMARY

The present application provides a secondary battery and an electric apparatus. The secondary battery designed in the present application is conducive to balancing the comprehensive performance of the battery, for example, to some extent, balancing the energy density, fast charging performance, and cycling performance.

In a first aspect, the present application provides a secondary battery including:
a positive electrode plate: including a lithium-containing transition metal phosphate, where the lithium-containing transition metal phosphate includes submicron-scale and micron-scale particles;
a negative electrode plate; and
an electrolyte including a lithium salt and a film-forming stabilizer, where the lithium salt includes a first lithium salt and a second lithium salt; where
the first lithium salt includes lithium hexafluorophosphate, and the second lithium salt includes one or both of lithium bis(fluorosulfonyl)imide and lithium bis(trifluoromethanesulfonyl)imide.

The advantages of the lithium-containing transition metal phosphate provided in the present application include but are not limited to the following: (1) the submicron-scale and micron-scale particles have a small-size effect, facilitating uniform stacking of the particles to improve the energy density of the electrode plate; and (2) the submicron-scale and micron-scale particles have a higher specific surface area and more grain boundaries, which, on the basis of reducing the depth and distance of lithium ion intercalation and deintercalation, provide more and faster lithium ion diffusion channels, thereby reducing the impedance of the positive electrode plate and improving the rate performance of the battery. However, as an active material of the positive electrode plate, the submicron-scale and micron-scale particles of lithium-containing transition metal phosphate also have defects, to be specific, the lithium-containing transition metal phosphate has strong moisture absorption, and this part of absorbed moisture is difficult to remove by conventional auxiliary means. For example, after baking for a period of time under specific conditions, trace moisture still remains. This trace moisture is likely to increase the probability of side reactions between the active material and the electrolyte during subsequent cyclic use of the battery, affecting the cycling performance of the battery. The design concept of the present application is to select an appropriate particle size for the lithium-containing transition metal phosphate and to match it with the electrolyte, so as to improve the energy density and rate performance of the lithium-ion battery and reduce the impact on the cycling performance.

The electrolyte selected in the present application is precisely in accordance with the above design concept to alleviate the problems caused by the strong moisture absorption of the lithium-containing transition metal phosphate. Specifically, the lithium salt in the electrolyte includes a first lithium salt and a second lithium salt, where the first lithium salt is an essential lithium salt for ensuring normal operation of the battery and includes but is not limited to lithium hexafluorophosphate. However, the first lithium salt is quite likely to react with trace moisture in a battery system, and a strong acid produced is likely to undergo a side reaction with an organic solvent in the electrolyte, so the first lithium salt and the second lithium salt are used in combination. The second lithium salt has good hydrolysis stability and includes but is not limited to one or both of lithium bis(fluorosulfonyl)imide (LiFSI) and lithium bis(trifluoromethanesulfonyl)imide (LiTFSI). This type of lithium salt is less sensitive to water than the first lithium salt. In addition, this type of lithium salt has high ionic conductivity to improve the rate performance of the battery. However, compared with the first lithium salt, the second lithium salt also has disadvantage, to be specific, the second lithium salt is more likely to corrode a current collector. Therefore, in the present application, on the premise of taking into account the respective advantages and disadvantages of the first lithium salt and the second lithium salt, the first lithium salt and the second lithium salt are used in combination to match with the lithium-containing transition metal phosphate. In addition, in the present application, a film-forming stabilizer is further added as an additive to the electrolyte, to improve the stability of an interface film of a positive electrode and a negative electrode and ultimately reduce the impact on the cycling performance of the battery. Therefore, the secondary battery designed in the present application is conducive to balancing the energy density, rate performance, cycling performance, and the like of the battery.

In some embodiments of the present application, the lithium-containing transition metal phosphate satisfies one or both of the following:
(1.1) a volumetric particle size distribution of the lithium-containing transition metal phosphate satisfies: Dv50 is 0.3 μm to 2.0 μm, 3.0 μm≤Dv90≤20 μm, and 0.1 μm≤Dv10≤1 μm; and
(1.2) the lithium-containing transition metal phosphate includes one, two, or more of lithium iron phosphate, lithium manganese phosphate, and lithium iron manganese phosphate.

In some embodiments of the present application, the Dv50 of the lithium-containing transition metal phosphate is 0.35 μm to 1.8 μm.

In some embodiments of the present application, the positive electrode plate satisfies one, two, or more of the following:
(2.1) a single-sided coating weight of the positive electrode plate is 0.25 g/1540.25 mm² to 0.50 g/1540.25 mm²;
(2.2) a mass percentage of the lithium-containing transition metal phosphate in the positive electrode plate is 90% to 98%; and
(2.3) a compacted density of the positive electrode plate is 2.4 g/cm³ to 2.7 g/cm³.

In some embodiments of the present application, the lithium salt satisfies one, two, or more of the following:
(3.1) a mass percentage of the first lithium salt is a, a mass percentage of the second lithium salt is b, and 0.2<a/b≤7;
(3.2) 2%≤a≤15%; and
(3.3) 0.2%≤b≤8%.

In some embodiments of the present application, the lithium salt satisfies the following conditions:
the mass percentage of the first lithium salt is a, and 4%≤a≤10%;
and/or
the mass percentage of the second lithium salt is b, and 0.8%≤b≤6%.

In some embodiments of the present application, the film-forming stabilizer satisfies one or both of the following:
(4.1) the film-forming stabilizer includes one or both of lithium fluorosulfonate and lithium difluorophosphate; and
(4.2) based on a total mass of the electrolyte, a mass percentage of the film-forming stabilizer is 0.02% to 2%.

In some embodiments of the present application, based on the total mass of the electrolyte, the mass percentage of the film-forming stabilizer is 0.1% to 1.5%.

In some embodiments of the present application, the film-forming stabilizer includes lithium fluorosulfonate and lithium difluorophosphate, and based on the total mass of the electrolyte, a mass percentage of lithium difluorophosphate is less than or equal to 1%, and a mass percentage of lithium fluorosulfonate is greater than or equal to 0.2% and less than 2%.

In some embodiments of the present application, the electrolyte includes a solvent, the solvent includes a carboxylate, and the carboxylate satisfies one or both of the following:
(5.1) the carboxylate has the following structural formula:

R1—COO—R2;
where R1 and R2 each independently include a substituted and/or unsubstituted C₁-C₅ alkyl; and
(5.2) based on the mass of the electrolyte, a mass percentage of the carboxylate is 5% to 70%.

In some embodiments of the present application, the electrolyte includes a solvent, the solvent includes a carboxylate, and the carboxylate satisfies one or both of the following:
(6.1) the carboxylate includes one or more of ethyl acetate, methyl acetate, ethyl propionate, propyl acetate, methyl propionate, and methyl butyrate; and
(6.2) based on the mass of the electrolyte, a mass percentage of the carboxylate is 10% to 60%.

In some embodiments of the present application, the electrolyte includes a solvent, the solvent includes a carboxylate and a carbonate, and the carbonate satisfies one or both of the following:
(7.1) based on the mass of the electrolyte, a mass percentage of the carbonate is greater than or equal to 5%; and
(7.2) the carbonate includes one, two, or more of ethylene carbonate, propylene carbonate, fluoroethylene carbonate, vinylene carbonate, dimethyl carbonate, diethyl carbonate, and ethyl methyl carbonate.

In some embodiments of the present application, the negative electrode plate satisfies one or both of the following:
(8.1) a single-sided coating weight of the negative electrode plate is 0.13 g/1540.25 mm² to 0.25 g/1540.25 mm²; and
(8.2) the negative electrode plate includes a carbon material.

A second aspect of the present application provides an electric apparatus including the secondary battery described in the first aspect.

The foregoing is merely an overview of the technical solutions of the present application. To better understand the technical means of the present application so that they can be implemented in accordance with the content of the specification, and to make the above and other objects, features, and advantages of the present application more apparent, specific embodiments of the present application are set forth below.

### BRIEF DESCRIPTION OF DRAWINGS

By reading the following detailed description of the preferred embodiments, various other advantages and benefits will become apparent to those of ordinary skill in the art. The drawings are only for the purpose of illustrating the preferred embodiments and are not to be considered as limiting the present application. Moreover, throughout the drawings, the same reference numerals denote the same parts. In the drawings:

FIG. 1 is a schematic structural diagram of a battery according to some embodiments of the present application;

FIG. 2 is a schematic structural exploded view of a battery according to some embodiments of the present application;

FIG. 3 is a schematic structural diagram of a vehicle according to some embodiments of the present application;

FIG. 4 is a schematic structural diagram of a battery pack according to some embodiments of the present application;

FIG. 5A is a schematic structural diagram of a positive electrode plate according to some embodiments of the present application; and

FIG. 5B is a schematic structural diagram of another positive electrode plate according to some embodiments of the present application.

The reference numerals in specific embodiments are as follows:
10000. vehicle;
1000. battery; 2000. controller; 3000. motor;
100. battery cell;
200. case; 210. first portion; 220. second portion;
10. secondary battery;
101. housing; 102. electrode assembly; 103. cover plate;
1. positive electrode plate;
11. positive electrode current collector;
12. positive electrode film layer;
x-axis direction: length or width direction of positive electrode plate; and
z-axis direction: thickness direction of positive electrode plate.

### DESCRIPTION OF EMBODIMENTS

The following specifically disclose an embodiment of a secondary battery and an electric apparatus of the present application in detail with appropriate reference to the drawings. However, unnecessary detailed descriptions may be omitted. For example, detailed descriptions of well-known matters and repeated descriptions of actually identical structures may be omitted. This is to avoid unnecessarily redundancy in the following description and to facilitate understanding by those skilled in the art. In addition, the drawings and the following description are provided for those skilled in the art to fully understand the present application and are not intended to limit the subject matter recited in the claims.

The “range” disclosed in the present application is defined in the form of a lower limit and an upper limit. A given range is defined by selecting a lower limit and an upper limit, and the selected lower limit and upper limit define a boundary of a specific range. Ranges defined in this manner may or may not include endpoints and may be arbitrarily combined, that is, any lower limit may be combined with any upper limit to form a range. For example, if ranges of 60-120 and 80-110 are listed for a specific parameter, it is understood that ranges of 60-110 and 80-120 are also contemplated. In addition, if the minimum range values listed are 1 and 2, and if the maximum range values listed are 3, 4, and 5, the following ranges are all contemplated: 1-3, 1-4, 1-5, 2-3, 2-4, and 2-5. In the present application, unless otherwise specified, the numerical range “a-b” represents an abbreviated representation of any real number combination between a and b, where a and b are both real numbers. For example, the numerical range “0-5” indicates that all real numbers between “0-5” have been listed herein, and “0-5” is merely an abbreviated representation of these numerical combinations. In addition, when a certain parameter is expressed as an integer greater than or equal to 2, it is equivalent to disclosing that the parameter is, for example, the integer 2, 3, 4, 5, 6, 7, 8, 9, 10, 11, 12, or the like.

Unless otherwise specified, all embodiments and optional embodiments of the present application may be combined with each other to form new technical solutions.

Unless otherwise specified, all technical features and optional technical features of the present application may be combined with each other to form new technical solutions.

Unless otherwise specified, all steps of the present application may be performed sequentially or randomly, preferably sequentially. For example, a method including steps (a) and (b) indicates that the method may include steps (a) and (b) performed sequentially, or may include steps (b) and (a) performed sequentially. For example, reference to the method possibly further including step (c) indicates that step (c) may be added to the method in any order, for example, the method may include steps (a), (b), and (c), may include steps (a), (c), and (b), may include steps (c), (a), and (b), or the like.

Unless otherwise specified, the terms “include” and “comprise” mentioned in the present application indicate open-ended or closed-ended. For example, the terms “include” and “comprise” may indicate that other components not listed may or may not be included or comprised.

Unless otherwise specified, in the present application, the term “or” is inclusive. For example, the phrase “A or B” means “A, B, or both A and B”. More specifically, any of the following conditions satisfies the condition “A or B”: A is true (or present) and B is false (or absent); A is false (or absent) and B is true (or present); or both A and B are true (or present).

Unless otherwise specified, in the present application, the terms “first”, “second”, and the like are used only to distinguish different objects and are not to be understood as indicating or implying relative importance or implicitly indicating the number, specific order, or primary-secondary relationship of the indicated technical features.

Unless otherwise specified, in the present application, “a plurality of” refers to two or more (including two). Similarly, “a plurality of groups” refers to two or more groups (including two groups), and “a plurality of pieces” refers to two or more pieces (including two pieces).

The term “alkyl” is intended to be a straight-chain saturated hydrocarbon structure having 1 to 20 carbon atoms. “Alkyl” is also intended to be a branched or cyclic hydrocarbon structure having 3 to 20 carbon atoms. When an alkyl having a specific carbon number is specified, all geometric isomers having that carbon number are intended to be encompassed. Thus, for example, “butyl” is meant to include n-butyl, sec-butyl, isobutyl, tert-butyl, and cyclobutyl; and “propyl” includes n-propyl, isopropyl, and cyclopropyl. Examples of alkyl include but are not limited to methyl, ethyl, n-propyl, isopropyl, cyclopropyl, n-butyl, isobutyl, sec-butyl, tert-butyl, cyclobutyl, n-pentyl, isopentyl, neopentyl, cyclopentyl, methylcyclopentyl, ethylcyclopentyl, n-hexyl, isohexyl, cyclohexyl, n-heptyl, octyl, cyclopropyl, cyclobutyl, norbornyl, and the like.

The term “substitute” includes substitution of a hydrogen atom in an alkyl by another group, and the number of substituted hydrogen atoms is determined by the number of hydrogen atoms.

Secondary batteries have been widely used in various products due to their advantages such as high energy density, long cycle life, safety, and reliability. In recent years, as the demand for secondary batteries serving as energy sources has increased significantly, higher requirements have been imposed on the performance of secondary batteries, such as the dynamic performance and cycling performance.

Lithium-containing transition metal phosphate is the most commonly used positive electrode active material, which has good thermal stability and low cost and exhibits excellent cycling performance. The shortcomings are that the lithium-containing transition metal phosphate exhibits poor rate performance and insufficient energy density in lithium-ion batteries.

In the prior art, one way to improve the rate performance and energy density of lithium-containing transition metal phosphate serving as a positive electrode active material in lithium-ion batteries is to optimize particles of the material. However, particle optimization also brings technical defects: increased moisture absorption, where this part of absorbed moisture is difficult to remove by conventional auxiliary means, resulting in increased side reactions with the electrolyte and thus affecting the cycling performance of the battery.

If the rate performance and energy density of lithium-containing transition metal phosphate serving as a positive electrode active material in lithium-ion batteries can be improved while the cycling performance is guaranteed, the performance of the secondary battery can be further improved.

Based on the above considerations, in order to solve the problem that lithium-containing transition metal phosphate serving as a positive electrode active material in lithium-ion batteries cannot balance the rate performance, energy density, and cycling performance, a secondary battery and an electric apparatus have been obtained through the above design concept and related experimental investigations.

A secondary battery provided in the present application includes: a positive electrode plate, a negative electrode plate, and an electrolyte, where the positive electrode plate includes a lithium-containing transition metal phosphate, and the lithium-containing transition metal phosphate includes submicron-scale and micron-scale particles. In addition, the electrolyte in the secondary battery includes a lithium salt and a film-forming stabilizer, where the lithium salt includes a first lithium salt and a second lithium salt, the first lithium salt includes lithium hexafluorophosphate, and the second lithium salt includes one or both of lithium bis(fluorosulfonyl)imide and lithium bis(trifluoromethanesulfonyl)imide.

In the present application, the lithium-containing transition metal phosphate is used as the active material in the positive electrode plate. The submicron-scale and micron-scale particles have a small-size effect, which facilitates uniform stacking of the particles to improve the energy density of the electrode plate. In addition, the submicron-scale and micron-scale particles have a higher specific surface area and more grain boundaries, which, on the basis of reducing the depth and distance of lithium ion intercalation and deintercalation, provide more and faster lithium ion diffusion channels, thereby reducing the impedance of the positive electrode plate and improving the rate performance of the battery. However, lithium-containing transition metal phosphate has specific moisture absorption, for example, absorbing moisture from the environment; when it forms submicron-scale and micron-scale particles, the moisture absorption is stronger, and this part of absorbed moisture is difficult to remove by conventional auxiliary means. For example, after baking for a period of time under specific conditions, trace moisture still remains. This trace moisture is likely to increase the probability of side reactions between the active material and the electrolyte during subsequent cyclic use of the battery, affecting the cycling performance of the battery. Moreover, since lithium-containing transition metal phosphate forms more lithium ion diffusion channels, these channels can also ensure sufficient infiltration by the electrolyte, so the side reactions are further enhanced. In order to minimize the problems caused by the strong moisture absorption of lithium-containing transition metal phosphate, in the present application, a second lithium salt having good hydrolysis stability and a film-forming stabilizer are used in combination in the electrolyte, and the amount of the first lithium salt used is appropriately reduced, to match with the small-size effect particles of lithium-containing transition metal phosphate and reduce the impact on the cycling performance of the battery. Therefore, the secondary battery designed in the present application is conducive to balancing the energy density, rate performance, and cycling performance of the battery.

The secondary battery provided in the present application alleviates the technical problems of insufficient energy density and poor rate performance existing when lithium-containing transition metal phosphate is used as a positive electrode active material, and achieves the technical purpose of improving the performance of the battery by balancing the energy density, rate performance, cycling performance, and the like of the battery. The battery may include an outer package. The outer package may be used to encapsulate an electrode assembly and an electrolyte. The electrode assembly includes a positive electrode plate, a negative electrode plate, and a separator, which may be formed by a winding process or a lamination process. The outer package of the battery may be a hard shell, such as a hard plastic shell, an aluminum shell, or a steel shell. The outer package of the battery may alternatively be a soft pouch, such as a pouch-type soft pack. The material of the soft pouch may be plastic, and examples of the plastic include polypropylene, polybutylene terephthalate, polybutylene succinate, and the like.

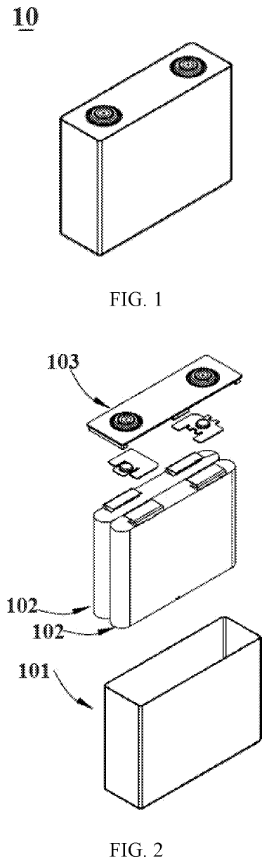

The present application imposes no particular limitation on the shape of the battery, which may be cylindrical, square, or any other shape. For example, FIG. 1 shows a square-structured secondary battery 10 as an example.

In some embodiments of the present application, with reference to FIG. 2, the outer package may include a housing 101 and a cover plate 103. The housing 101 may include a bottom plate and side plates connected to the bottom plate, and the bottom plate and the side plates enclose an accommodating cavity. The housing 101 has an opening in communication with the accommodating cavity, and the cover plate 103 can cover the opening to close the accommodating cavity. A positive electrode plate, a negative electrode plate, and a separator may be formed into an electrode assembly 102 by a winding process or a lamination process. The electrode assembly 102 is encapsulated in the accommodating cavity. The electrolyte infiltrates into the electrode assembly 102. There may be one or more electrode assemblies 102 in the secondary battery 10, which may be selected by those skilled in the art according to specific actual needs.

The electrode assembly provided in the present application is applied to a battery, which is conducive to improving the performance of the battery. The battery may be used as a power source for an electric apparatus or as an energy storage unit for an electric apparatus. The electric apparatus is applied in the field of power, such as mobile devices (for example, mobile phones and laptops), electric vehicles (for example, battery electric vehicles, hybrid electric vehicles, plug-in hybrid electric vehicles, electric bicycles, electric scooters, electric golf carts, and electric trucks), electric trains, ships, satellites, and energy storage systems, but is not limited to the above fields.

In some embodiments of the present application, for convenience of description, the electric apparatus being a vehicle is used as an example for description. The battery provided in the present application has good rate performance, so the vehicle has a high starting speed, and the battery has high energy density, thereby providing a longer battery life for the vehicle in an effective space.

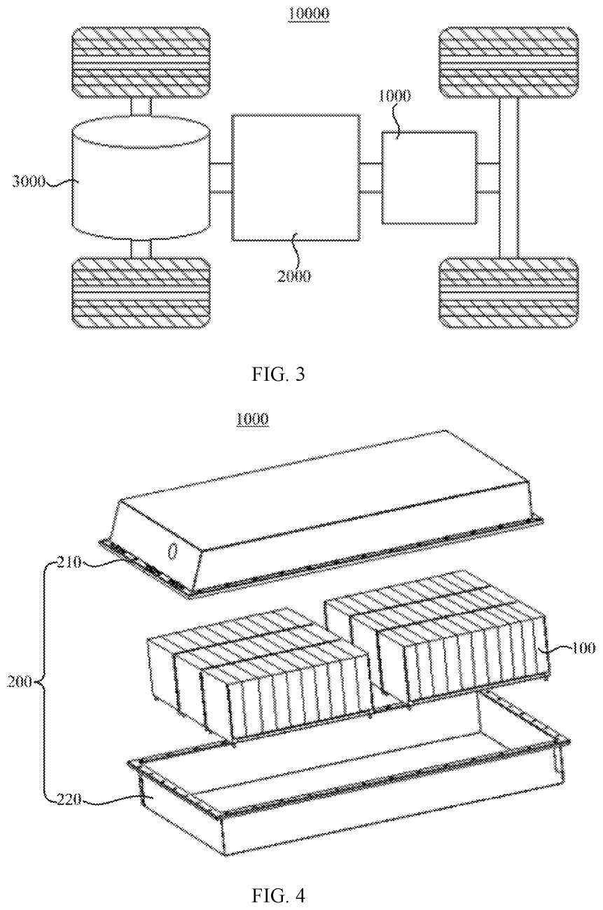

Reference is made to FIG. 3, where FIG. 3 is a schematic structural diagram of a vehicle 10000 according to some embodiments of the present application. The vehicle 10000 may be a fuel vehicle, a gas vehicle, or a new energy vehicle, and the new energy vehicle may be a battery electric vehicle, a hybrid electric vehicle, an extended-range vehicle, or the like. The vehicle 10000 is internally provided with a battery 1000, and the battery 1000 may be disposed at the bottom, front, or rear of the vehicle 10000. The battery 1000 may be used for power supply of the vehicle 10000, for example, the battery 1000 may serve as an operating power source of the vehicle 10000. The vehicle 10000 may further include a controller 2000 and a motor 3000, and the controller 2000 is configured to control the battery 1000 to supply power to the motor 3000, for example, for the operating power demands of the vehicle 10000 during starting, navigation, and driving.

In some embodiments of the present application, the battery 1000 may not only serve as an operating power source of the vehicle 10000, but also serve as a driving power source of the vehicle 10000, replacing or partially replacing fuel or natural gas to provide driving power for the vehicle 10000.

Reference is made to FIG. 4, where FIG. 4 is an exploded view of a battery 1000 according to some embodiments of the present application. The battery 1000 includes a case 200 and a battery cell 100. Conventional battery cells include primary batteries or secondary batteries, and the present application specifically protects a secondary battery. The battery cell 100 is accommodated in the case 200. The case 200 is configured to provide an accommodation space for the battery cell 100, and the case 200 may adopt various structures.

In some embodiments, the case 200 may include a first portion 210 and a second portion 220, the first portion 210 and the second portion 220 cover each other, and the first portion 210 and the second portion 220 jointly define an accommodation space for accommodating the secondary battery 100. The second portion 220 may be a hollow structure with one end open, the first portion 210 may be a plate-like structure, and the first portion 210 covers the open side of the second portion 220, so that the first portion 210 and the second portion 220 jointly define the accommodation space. The first portion 210 and the second portion 220 may alternatively both be hollow structures with one side open, and the open side of the first portion 210 covers the open side of the second portion 220. Certainly, the case 200 formed by the first portion 210 and the second portion 220 may have various shapes, such as a cylinder and a cuboid.

In the battery 1000, there may be a plurality of battery cells 100, and the plurality of battery cells 100 may be connected in series, in parallel or in series-parallel, where being connected in series-parallel means that the plurality of battery cells 100 are connected both in series and in parallel. The plurality of battery cells 100 may be directly connected in series, in parallel, or in series-parallel, and then an entirety formed by the plurality of battery cells 100 is accommodated in the case 200. Certainly, the battery 1000 may alternatively be in the form of a battery module formed by first connecting a plurality of battery cells 100 in series, in parallel, or in series-parallel, and then a plurality of battery modules are connected in series, in parallel, or in series-parallel to form an entirely that is accommodated in the case 200. The battery 1000 may further include other structures, for example, the battery 1000 may further include a bus component for realizing electrical connection between the plurality of battery cells 100.

### Secondary Battery

In some embodiments, the present application discloses a secondary battery including: a positive electrode plate, a negative electrode plate, and an electrolyte, where the positive electrode plate includes a lithium-containing transition metal phosphate, and the lithium-containing transition metal phosphate includes submicron-scale and micron-scale particles. In addition, the electrolyte in the secondary battery includes a lithium salt and a film-forming stabilizer, where the lithium salt includes a first lithium salt and a second lithium salt, the first lithium salt includes lithium hexafluorophosphate, and the second lithium salt includes one or both of lithium bis(fluorosulfonyl)imide and lithium bis(trifluoromethanesulfonyl)imide.

The positive electrode plate of the present application includes a positive electrode film layer, the positive electrode film layer is formed on one or both surfaces of the positive electrode plate, and the lithium-containing transition metal phosphate serves as an active material of the positive electrode film layer. A preparation method of the lithium-containing transition metal phosphate includes preparing large-particle salt by using a conventional preparation method in the art, and then performing grinding to obtain submicron-scale and micron-scale particles. The micron-scale particles in the present application include particles having a particle size greater than 1 μm and less than or equal to 50 μm, and the submicron-scale particles include particles having a particle size less than 1 μm. The submicron-scale particles in the present application include particles having a particle size greater than or equal to 0.1 μm and less than 1 μm. If the particle size of the lithium-containing transition metal phosphate is represented by a particle size distribution, it includes particles having a particle size less than 1 μm and particles having a particle size greater than 1 μm. An average particle size of the submicron-scale particles needs to be statistically calculated according to a specific number in each particle size range. The preparation method of the lithium-containing transition metal phosphate in the present application includes but is not limited to mixing various metal precursors to uniformity and then making them react through a solid-phase method or a liquid-phase method, where the solid-phase method includes but is not limited to a high-temperature solid-phase reaction method, a carbothermal reduction method, a microwave synthesis method, and a pulsed laser deposition method. The liquid-phase method includes but is not limited to a sol-gel method, a hydrothermal synthesis method, a precipitation method, and a solvothermal synthesis method.

The advantages of the lithium-containing transition metal phosphate provided in the present application include but are not limited to the following: (1) the submicron-scale and micron-scale particles have a small-size effect, facilitating uniform stacking of the particles to improve the energy density of the electrode plate; and (2) the submicron-scale and micron-scale particles have a higher specific surface area and more grain boundaries, which, on the basis of reducing the depth and distance of lithium ion intercalation and deintercalation, provide more and faster lithium ion diffusion channels, thereby reducing the impedance of the positive electrode plate and improving the rate performance of the battery. However, as an active material of the positive electrode film layer, the lithium-containing transition metal phosphate also has defects, to be specific, the lithium-containing transition metal phosphate has strong moisture absorption, and when it forms submicron-scale and micron-scale particles, the moisture absorption is stronger, and this part of absorbed moisture is difficult to remove by conventional auxiliary means. For example, after baking for a period of time under specific conditions, trace moisture still remains. This trace moisture is likely to increase the probability of side reactions between the active material and the electrolyte during subsequent cyclic use of the battery, affecting the cycling performance of the battery. The design concept of the present application is to alleviate the technical problems of poor energy density and rate performance of the lithium-containing transition metal phosphate serving as the active material of the positive electrode film layer in lithium-ion batteries, and to reduce the impact on the cycling performance.

The electrolyte selected in the present application is precisely in accordance with the above design concept to alleviate the problems caused by the strong moisture absorption of the lithium-containing transition metal phosphate. Specifically, the lithium salt in the electrolyte includes a first lithium salt and a second lithium salt, where the first lithium salt is an essential lithium salt for ensuring normal operation of the battery and includes but is not limited to lithium hexafluorophosphate. However, the first lithium salt is quite likely to react with trace moisture in a battery system, and a strong acid produced is likely to undergo a side reaction with an organic solvent in the electrolyte, so the first lithium salt and the second lithium salt are used in combination. The second lithium salt has good hydrolysis stability and includes but is not limited to one or both of lithium bis(fluorosulfonyl)imide (LiFSI) and lithium bis(trifluoromethanesulfonyl)imide (LiTFSI). This type of lithium salt is less sensitive to water than the first lithium salt. In addition, this type of lithium salt has high ionic conductivity to improve the rate performance of the battery. However, compared with the first lithium salt, the second lithium salt also has disadvantage, to be specific, it is more likely to corrode the current collector. Therefore, in the present application, on the premise of taking into account the respective advantages and disadvantages of the first lithium salt and the second lithium salt, the first lithium salt and the second lithium salt are used in combination to match with the small-size effect particles of the lithium-containing transition metal phosphate. In addition, in the present application, a film-forming stabilizer is added as an additive to the electrolyte, to improve the stability of an interface film of a positive electrode and a negative electrode and ultimately reduce the impact on the cycling performance of the battery. Therefore, the secondary battery designed in the present application is conducive to balancing the energy density, rate performance, cycling performance, and the like of the battery.

In some embodiments of the present application, the lithium-containing transition metal phosphate satisfies one or both of the following:
(1.1) a volumetric particle size distribution of the lithium-containing transition metal phosphate satisfies: Dv50 is 0.3 μm to 2.0 μm, 3.0 μm≤Dv90≤20 μm, and 0.1 μm≤Dv10≤1 μm; and
(1.2) the lithium-containing transition metal phosphate includes one, two, or more of lithium iron phosphate, lithium manganese phosphate, and lithium iron manganese phosphate.

The Dv50 of the lithium-containing transition metal phosphate in the present application is a size at which the volume of particles with a particle size greater than this size accounts for 50% and the volume of particles with a particle size less than this size also accounts for 50%, which is also referred to as a median particle size and is usually used to represent a medium particle size of particles. Compared with the micron-scale particles conventionally used in the prior art, the particle size of the particles in the present application is reduced to some extent, but is not reduced to the nanoscale. This is because nanoscale particles have stronger moisture absorption and are prone to sticking together. The Dv90 of the lithium-containing transition metal phosphate in the present application is a size at which the volume of particles with a particle size less than this size accounts for 90%, and the Dv10 is a size at which the volume of particles with a particle size less than this size accounts for 10%. The Dv90 or Dv10 can both be obtained by using a conventional measurement method in the art, for example, using a particle size analyzer to measure a particle size distribution and then perform statistical calculation. In these embodiments of the present application, measurement is performed with reference to a laser diffraction particle size analysis method, specifically with reference to the standard GB/T19077-2016 to obtain a particle size distribution diagram, followed by calculation to obtain a result.

The median particle size Dv50 in the present application affects the compacted density, the specific surface area, and the like of the lithium-containing transition metal phosphate. Generally, under the same conditions, a larger median particle size Dv50 indicates a larger compacted density but a smaller specific surface area. In these embodiments of the present application, the Dv50 is 0.3 μm to 2.0 μm, 3.0 μm≤Dv90≤20 μm, and 0.1 μm≤Dv10≤1 μm, to improve the energy density and rate performance of the secondary battery, as well as allow for a use in combination with a subsequent electrolyte. In these embodiments, the present application discloses that the Dv50 is any one of 0.3 μm, 0.35 μm, 0.5 μm, 1.0 μm, 1.5 μm, 1.8 μm, and 2.0 μm, or satisfies any one of the above range values. In these embodiments, the present application discloses that the Dv90 is any one of 20 μm, 15 μm, 10 μm, 8 μm, 6 μm, 5 μm, 4 μm, 3.8 μm, 3.5 μm, and 3 μm. In these embodiments, the present application discloses that the Dv10 is any one of 0.1 μm, 0.2 μm, 0.22 μm, 0.25 μm, 0.28 μm, 0.45 μm, 0.5 μm, 0.9 μm, and 1.0 μm.

The lithium-containing transition metal phosphate in the present application includes one, two, or more of lithium iron phosphate, lithium manganese phosphate, and lithium iron manganese phosphate. A chemical formula of lithium iron phosphate, lithium manganese phosphate, and lithium iron manganese phosphate is Li₁₋ₓFe_{y}Mn_{1-y}PO₄, 0≤x<1, and 0≤y≤1. The lithium-containing transition metal phosphate having this chemical formula has an olivine crystal structure, and the good stability of the crystal structure during lithium deintercalation and intercalation is conducive to ensuring high cycling stability of the battery. In addition, the battery formed by assembling the positive electrode active material having the above chemical formula in the present application is accompanied by lithium deintercalation and consumption during charging and discharging, and the molar content of lithium varies when the battery is discharged to different states. The above definition includes a percentage of lithium in different charging and discharging states of the battery under a voltage of 2 V to 5 V.

In some embodiments of the present application, the Dv50 of the lithium-containing transition metal phosphate is 0.35 μm to 1.8 μm.

In these embodiments of the present application, the Dv50 of the lithium-containing transition metal phosphate particles is 0.35 μm to 1.8 μm, and the lithium-containing transition metal phosphate particles having this median particle size are used in combination with the electrolyte to facilitate further improvement of the energy density and rate performance of the secondary battery.

In some embodiments of the present application, the positive electrode plate satisfies one, two, or more of the following:
(1.1) a single-sided coating weight of the positive electrode plate is 0.25 g/1540.25 mm² to 0.50 g/1540.25 mm²;
(1.2) a mass percentage of the lithium-containing transition metal phosphate in the positive electrode plate is 90% to 98%; and
(1.3) a compacted density of the positive electrode plate is 2.4 g/cm³ to 2.7 g/cm³.

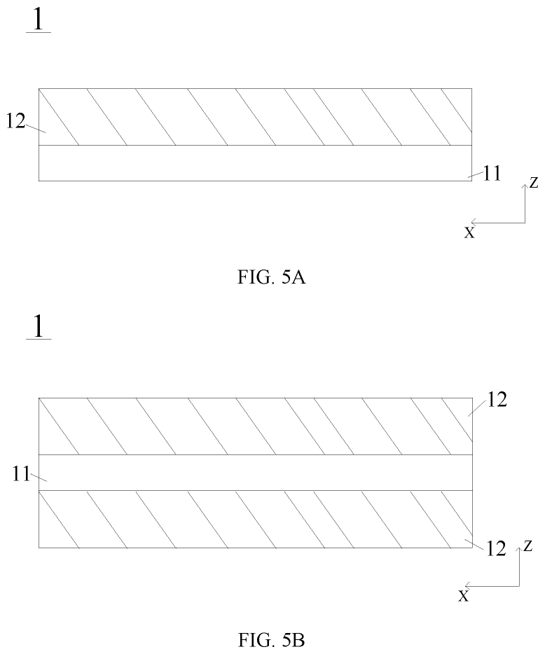

The positive electrode film layer of the present application may be formed on one or both surfaces of the positive electrode plate, as illustrated in FIG. 5A or 5B. A formation method of the positive electrode film layer includes use of a conventional coating method in the art: applying a positive electrode slurry including lithium-containing transition metal phosphate on one or both surfaces of a current collector, followed by drying and cold pressing to obtain a positive electrode film layer. A single-sided coating weight of the positive electrode film layer may be calculated according to an actual coating situation. The single-sided coating weight of the positive electrode plate in the present application may be any one of 0.25 g/1540.25 mm², 0.30 g/1540.25 mm², 0.35 g/1540.25 mm², 0.40 g/1540.25 mm², 0.45 g/1540.25 mm², and 0.50 g/1540.25 mm², or satisfy any one of the above range values. The selection of the single-sided coating weight of the positive electrode plate in the present application to be 0.25 g/1540.25 mm² to 0.50 g/1540.25 mm² is achieved on the basis of the micron-scale and submicron-scale active materials selected in the present application in combination with specific coating conditions. Compared with a conventional coating weight of lithium-containing transition metal phosphate in the art, this coating weight is increased, and it can be clearly expected that the energy density of the battery is well improved.

In addition to the lithium-containing transition metal phosphate, the positive electrode film layer of the present application further includes a positive electrode conductive agent, a positive electrode binder, and the like, where, based on a total percentage of components in the positive electrode film layer, a mass percentage of the lithium-containing transition metal phosphate is 90% to 98%, and in these embodiments, a mass percentage of the lithium-containing transition metal phosphate may be any one of 90%, 92%, 94%, 95%, 96%, and 98%, or satisfy any one of the above range values. The positive electrode active material having this mass percentage facilitates combination with a particle size thereof to ensure the above coating weight.

The compacted density of the positive electrode plate in the present application may be used to characterize the energy density of the positive electrode active material in the entire positive electrode plate. Compacted density of positive electrode plate=areal density of positive electrode plate/thickness of positive electrode plate, where a thickness of the positive electrode plate includes a distance between one end face of the positive electrode plate and another oppositely disposed end face. The thickness of the positive electrode plate may be detected using devices and methods well known in the art, and the relevant detection methods may refer to domestic and foreign detection standards, domestic and foreign enterprise standards, and the like, and those skilled in the art may also adaptively change some detection steps/instrument parameters and the like from the perspective of detection accuracy to obtain more accurate detection results. Elements included in the lithium-containing transition metal phosphate in the positive electrode plate of the present application may be qualitatively or quantitatively determined using one detection method, or qualitatively or quantitatively determined by combination of use of several detection methods. For example, the elements are determined according to GB/T 17359-2012 Microbeam Analysis-Quantitative Analysis Using Energy Dispersive Spectrometry, or for example, an average value is obtained by multiple measurements of a measuring instrument such as a micrometer.

In these embodiments, the present application discloses that the compacted density of the positive electrode plate is any one of 2.4 g/cm³, 2.46 g/cm³, 2.48 g/cm³, 2.55 g/cm³, 2.6 g/cm³, 2.62 g/cm³, 2.68 g/cm³, 2.69 g/cm³, and 2.7 g/cm³, or satisfies any one of the above range values, and the compacted density having this value has a correlation with the type, percentage, and coating weight of the positive electrode active material in the positive electrode film layer.

In some embodiments of the present application, in addition to the lithium-containing transition metal phosphate that serves as the positive electrode active material, the positive electrode film layer further includes a positive electrode conductive agent and a positive electrode binder. In these embodiments, the present application discloses that a mass ratio satisfies: lithium-containing transition metal phosphate: positive electrode conductive agent: positive electrode binder=(90% to 98%): (0.5% to 5%): (0.5% to 5%). The positive electrode conductive agent includes but is not limited to one or a combination of two or more of graphite, superconducting carbon, carbon black (such as acetylene black, Ketjen black, and Super P), carbon dots, carbon nanotubes, graphene, and carbon nanofiber. The positive electrode binder includes but is not limited to one or a combination of two or more of polyvinylidene fluoride (PVDF), polytetrafluoroethylene (PTFE), vinylidene fluoride-tetrafluoroethylene-propylene terpolymer, vinylidene fluoride-hexafluoropropylene-tetrafluoroethylene terpolymer, tetrafluoroethylene-hexafluoropropylene copolymer, fluoroacrylate resin, styrene-butadiene rubber, polyacrylic acid, sodium polyacrylate, polyacrylamide, polyvinyl alcohol, sodium alginate, polymethacrylic acid, and carboxymethyl chitosan.

In some embodiments of the present application, a preparation method of the positive electrode plate includes: mixing components with a solvent at a specific mass ratio to obtain a positive electrode slurry, and applying the positive electrode slurry on one or both surfaces of a positive electrode current collector, followed by heating, drying, and cooling to obtain a positive electrode plate including a positive electrode film layer. In these embodiments, the present application discloses that a heating and baking temperature is 90° C. to 120° C., for example, it may be 90° C., 95° C., 100° C., 105° C., 110° C., 115° C., 120° C., or the like. Regulating the baking temperature can facilitate volatilization of the solvent and curing of the slurry while preventing the positive electrode active material and additives from thermal decomposition due to overheating. In addition, the solvent used for preparing the positive electrode slurry includes one or more of N-methylpyrrolidone (NMP), N,N-dimethylformamide (DMF), N,N-diethylformamide (DEF), dimethyl sulfoxide (DMSO), pyridine, and tetrahydrofuran (THF). By selecting these solvents, the stability and uniform dispersion of the positive electrode active material in the slurry can be improved, and the solubility of the additives in the slurry can be improved, solving the problems such as instability, easy delamination, and sedimentation of the slurry. The selected solvent is a non-aqueous system, which can solve the problem of hydrolysis of the additives due to heating.

In some embodiments of the present application, it is further disclosed that the positive electrode current collector may be a metal foil or a composite current collector, where the metal foil may be an aluminum foil, and the composite current collector may include a polymer substrate and a metal layer formed on at least one surface of the polymer substrate. The composite current collector may be formed by forming a metal material, such as aluminum, aluminum alloy, nickel, nickel alloy, titanium, titanium alloy, silver, or silver alloy on a polymer substrate such as polypropylene (PP), polyethylene terephthalate (PET), polybutylene terephthalate (PBT), polystyrene (PS), or polyethylene (PE).

In some embodiments of the present application, the lithium salt satisfies one, two, or more of the following:
(3.1) a mass percentage of the first lithium salt is a, a mass percentage of the second lithium salt is b, and 0.2<a/b≤7;
(3.2) 2%≤a≤15%; and
(3.3) 0.2%≤b≤8%.

As described above, the first lithium salt is quite likely to react with trace moisture in a battery system, and the second lithium salt is more likely to corrode the current collector. In the present application, the first lithium salt and the second lithium salt are used in combination, and their percentages are controlled, to improve the effect of the use in combination. In order to further provide the usage amounts of the first lithium salt and the second lithium salt in the electrolyte, the present application provides a specific relationship between their percentages: 0.2<a/b≤7. In these embodiments, a/b may be any one of 0.25, 0.3, 0.4, 0.5, 0.6, 0.7, 0.8, 0.9, 1.0, 2.0, 3.0, 4.0, 5.0, 6.0, and 7.0, or satisfy any one of the above range values. In the present application, the percentages of the first lithium salt and the second lithium salt match with each other, and the formed lithium salt has the advantages such as low sensitivity to water and organic solvents, which is conducive to reducing side reactions to reduce the impact on the cycling stability of the battery. Specific components and percentages in the electrolyte of the present application may be determined by methods known in the art. For example, the components and percentages may be determined by gas chromatography, gas chromatography-mass spectrometry (GC-MS), ion chromatography (IC), liquid chromatography (LC), nuclear magnetic resonance spectroscopy (NMR), inductively coupled plasma optical emission spectrometry (ICP-OES), or the like.

Specifically, in some embodiments, the present application discloses that the mass percentage a of the first lithium salt satisfies: 2%≤a≤15%. Compared with the percentage corresponding to lithium hexafluorophosphate serving as the first lithium salt in the prior art, the percentage of the first lithium salt selected in the present application is reduced. In addition, in these embodiments, the mass percentage a of the first lithium salt may be any one of 2%, 2.5%, 3%, 3.5%, 4%, 4.5%, 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5%, and 15%, or satisfy any one of the above range values.

In addition, in the present application, a second lithium salt having a specific percentage is selected, and a mass percentage of the second lithium salt may be any one of 0.2%, 0.5%, 0.8%, 1%, 1.4%, 2%, 2.5%, 3%, 4%, 5%, 6%, 7%, and 8%, or satisfy any one of the above range values.

In some embodiments of the present application, the lithium salt satisfies the following conditions:
a mass percentage of the first lithium salt is a, and 4%≤a≤10%;
and/or
a mass percentage of the second lithium salt is b, and 0.8%≤b≤6%.

In these embodiments of the present application, the mass percentage of the first lithium salt satisfies: 4%≤a≤10%, and the mass percentage of the second lithium salt satisfies 0.8%≤b≤6%, so that the percentages of the first lithium salt and the second lithium salt match each other better.

In some embodiments of the present application, the film-forming stabilizer satisfies one or both of the following:
(4.1) the film-forming stabilizer includes one or both of lithium fluorosulfonate and lithium difluorophosphate; and
(4.2) based on the total mass of the electrolyte, a mass percentage of the film-forming stabilizer is 0.02% to 2%.

The film-forming stabilizer selected in the present application has the advantages of high stability, such as high voltage resistance and high temperature or low temperature resistance, to improve the stability of the electrolyte as well as promote the formation of a stable interface film between lithium ions and the electrolyte at a positive electrode interface and/or a negative electrode interface. The interface film includes an SEI film and a CEI film, where the SEI film is in-situ applied on a surface of the negative electrode active material, and the CEI film is in-situ applied on a surface of the positive electrode active material, thereby improving the cycling stability of the battery by reducing side reactions. Specifically, lithium fluorosulfonate and/or lithium difluorophosphate can strengthen the film formation of the positive and negative electrodes, effectively reduce the catalytic oxidation reaction of the electrolyte on the surfaces of the positive and negative electrodes, and reduce the side reactions at the interfaces between the electrolyte and the positive and negative electrodes under high voltage and/or high temperature and/or low temperature, thereby effectively improving the cycling performance of the battery. In these embodiments of the present application, the mass percentage of the film-forming stabilizer is 0.02% to 2%, which is affected by the solubility of each film-forming stabilizer, for example, the solubility of lithium difluorophosphate in an organic solvent is not high, such as 1% in a carbonate solvent and 3% to 4% in carboxylate such as ethyl acetate, and if the percentage is higher, the electrolyte becomes turbid. In addition, the film-forming stabilizer with this percentage is related to a total percentage of the lithium salt in the electrolyte. Generally, when the percentage of the lithium salt is high, the percentage of the matching film-forming stabilizer is relatively high; otherwise, it is relatively reduced. In these embodiments, the present application specifically discloses that the mass percentage of the film-forming stabilizer may be any one of 0.02%, 0.05%, 0.08%, 0.1%, 0.15%, 0.2%, 0.25%, 0.3%, 0.35%, 0.4%, 0.45%, 0.5%, 0.55%, 0.6%, 0.65%, 0.7%, 0.75%, 0.8%, 0.85%, 0.9%, 0.95%, 1.0%, 1.05%, 1.1%, 1.15%, 1.2%, 1.25%, 1.3%, 1.35%, 1.4%, 1.45%, 1.5%, 1.55%, 1.6%, 1.65%, 1.7%, 1.75%, 1.8%, 1.85%, 1.9%, 1.95%, and 2.0%, or satisfy any one of the above range values.

In some embodiments of the present application, based on the total mass of the electrolyte, the mass percentage of the film-forming stabilizer is 0.1% to 1.5%. In these embodiments of the present application, the mass percentage of the film-forming stabilizer is 0.1% to 1.5% to better match with a specific percentage of the lithium salt and further balance the energy density, rate performance, cycling performance, and the like of the battery.

In some embodiments of the present application, the film-forming stabilizer includes lithium fluorosulfonate and lithium difluorophosphate, and based on the total mass of the electrolyte, a mass percentage of lithium difluorophosphate is less than or equal to 1%, and a mass percentage of lithium fluorosulfonate is greater than or equal to 0.2% and less than 2%.

In the present application, lithium fluorosulfonate and lithium difluorophosphate are both added to the electrolyte as film-forming stabilizers to better match with the above lithium salt. Affected by the solubility of the lithium difluorophosphate in the electrolyte, the mass percentage of the lithium difluorophosphate is less than or equal to 1%, such as 0.9% and 0.8%; and the mass percentage of the lithium difluorophosphate in the electrolyte may alternatively be greater than 1%, such as 2%. The mass percentage of the lithium fluorosulfonate used in combination with the lithium difluorophosphate is greater than or equal to 0.2% and less than 2%, for example, may be any one of 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, and 1.95%, or satisfy any one of the above range values.

In some embodiments of the present application, the electrolyte includes a solvent, the solvent includes a carboxylate, and the carboxylate satisfies one or both of the following:
(5.1) the carboxylate has the following structural formula:

R1—COO—R2;
where R1 and R2 each independently include a substituted and/or unsubstituted C1-C5 alkyl; and
(5.2) based on the mass of the electrolyte, a mass percentage of the carboxylate is 5% to 70%.

The solvent of the present application includes a carboxylate, and the carboxylate has relatively stable properties, is less likely to be oxidized and reduced, and has good compatibility with the above lithium salt and additives. In addition, when the solvent includes a carboxylate, the electrolyte can have lower viscosity and smaller surface tension. When the carboxylate is used in combination with lithium-containing transition metal phosphate having more lithium ion diffusion channels, sufficient and effective contact between the lithium-containing transition metal phosphate and the electrolyte is facilitated to improve the rate performance of the battery. The carboxylate selected in these embodiments of the present application is mainly a linear carboxylate, because the viscosity of the linear carboxylate is lower, allowing the carboxylate to better match with lithium-containing transition metal phosphate in use. In these embodiments, the present application further discloses that the mass percentage of the carboxylate is 5% to 70%, where the mass percentage of the carboxylate may be any one of 5%, 10%, 15%, 20%, 25%, 30%, 35%, 40%, 45%, 50%, 55%, 60%, 65%, and 70%, or satisfy any one of the above range values.

In some embodiments of the present application, the electrolyte includes a solvent, the solvent includes a carboxylate, and the carboxylate satisfies one or both of the following:
(6.1) the carboxylate includes one or more of ethyl acetate, methyl acetate, ethyl propionate, propyl acetate, methyl propionate, and methyl butyrate; and
(6.2) based on the mass of the electrolyte, a mass percentage of the carboxylate is 10% to 60%.

As an example of the carboxylate, the carboxylate includes one or more of ethyl acetate, methyl acetate, ethyl propionate, propyl acetate, methyl propionate, and methyl butyrate. Carboxylate solvents have lower viscosity, and when a variety of carboxylate solvents are used in combination, the electrolyte can have lower surface tension.

In some embodiments of the present application, the electrolyte includes a solvent, the solvent includes a carboxylate and a carbonate, and the carbonate satisfies one or both of the following:
(7.1) based on the mass of the electrolyte, a mass percentage of the carbonate is greater than or equal to 5%; and
(7.2) the carbonate includes one, two, or more of ethylene carbonate, propylene carbonate, fluoroethylene carbonate, vinylene carbonate, dimethyl carbonate, diethyl carbonate, and ethyl methyl carbonate.

The lithium salt selected in the present application has better solubility in carbonates than in carboxylates, so in the present application, a carboxylate and a carbonate are used in combination, so as to reduce the viscosity of the electrolyte without affecting the solubility of the lithium salt, thereby facilitating the use in combination with lithium-containing transition metal phosphate.

As an example of the carbonate, the carbonate includes one, two, or more of ethylene carbonate, propylene carbonate, fluoroethylene carbonate, vinylene carbonate, dimethyl carbonate, diethyl carbonate, and ethyl methyl carbonate. Selecting the exemplified carbonate is conducive to better matching with the carboxylate.

The electrolyte of the present application may be prepared according to a conventional method in the art. For example, the film-forming additive, the solvent, the lithium salt, and the like may be uniformly mixed to obtain the electrolyte. There is no particular limitation on an addition order of the materials, for example, the additive, the lithium salt, and the like may be added to a non-aqueous solvent and uniformly mixed to obtain a non-aqueous electrolyte.

In the present application, each component and its percentage in the electrolyte may be determined according to methods known in the art. For example, they may be determined by gas chromatography-mass spectrometry (GC-MS), ion chromatography (IC), liquid chromatography (LC), nuclear magnetic resonance spectroscopy (NMR), and the like.

It should be noted that during testing of the electrolyte of the present application, a freshly prepared electrolyte may be directly taken, or the electrolyte may be obtained from a secondary battery. An exemplary method for obtaining the electrolyte from a secondary battery includes the following steps: discharging the secondary battery to a discharge cut-off voltage (for safety reasons, the battery is generally in a fully discharged state), then performing centrifugal treatment, and then taking an appropriate amount of the liquid obtained by the centrifugal treatment, which is the non-aqueous electrolyte. The non-aqueous electrolyte may alternatively be directly obtained from a liquid injection port of the secondary battery.

In some embodiments of the present application, the negative electrode plate satisfies one or both of the following:
(8.1) a single-sided coating weight of the negative electrode plate is 0.13 g/1540.25 mm² to 0.25 g/1540.25 mm²; and
(8.2) the negative electrode plate includes a carbon material.

The negative electrode plate of the present application includes a negative electrode film layer, where the negative electrode film layer may be formed on one or both surfaces of the negative electrode plate. The formation of the negative electrode plate includes applying a negative electrode slurry including a carbon material on one or both surfaces of a current collector by using a conventional coating method in the art, followed by drying and cold pressing to obtain a negative electrode plate. The single-sided coating weight of the positive electrode plate may be calculated according to the actual coating situation. The single-sided coating weight of the negative electrode plate in the present application may be any one of 0.13 g/1540.25 mm², 0.15 g/1540.25 mm², 0.18 g/1540.25 mm², 0.20 g/1540.25 mm², and 0.25 g/1540.25 mm², or satisfy any one of the above range values. The selection of the single-sided coating weight of the negative electrode plate in the present application to be 0.13 g/1540.25 mm² to 0.25 g/1540.25 mm² is achieved on the basis of the carbon material selected in the present application in combination with specific coating conditions. The negative electrode plate having this coating amount matches with the positive electrode plate to improve the energy density of the battery.

The carbon material of the present application includes graphitized carbon and amorphous carbon, where the graphitized carbon includes one or more of natural graphite, artificial graphite, composite graphite, and mesocarbon microbeads, and the amorphous carbon includes any one of hard carbon and soft carbon. The natural graphite, artificial graphite, composite graphite, or mesocarbon microbeads in the present application may be prepared by any conventional preparation method in the art. In some embodiments of the present application, it is disclosed that the graphitized carbon includes artificial graphite.

In addition to the active material, the negative electrode film layer of the present application further includes a conductive agent, a thickener, a binder, and the like, where the conductive agent includes but is not limited to one or a combination of two of graphite, superconducting carbon, carbon black (such as acetylene black, Ketjen black, and Super P), carbon dots, carbon nanotubes, graphene, and carbon nanofiber; the thickener includes cellulose and a sodium salt thereof, and the cellulose includes methyl cellulose, carboxymethyl cellulose, hydroxyethyl cellulose, and the like; and the binder includes but is not limited to polyvinyl alcohol, polyethylene glycol, sodium carboxymethyl cellulose, polyethylene oxide, polyacrylic acid, polyacrylamide, sodium alginate, styrene-butadiene rubber (SBR), and the like.

In some embodiments, the present application discloses that a mass ratio of the carbon material, the conductive agent, the thickener, and the binder is (90 to 97): (0.5 to 3): (0.5 to 3): (0.5 to 3).

In some embodiments, the present application discloses that the negative current collector includes but is not limited to a metal foil or a composite current collector, the metal foil may be a copper foil, and the composite current collector may include a polymer substrate and a metal layer formed on at least one surface of the polymer substrate. The composite current collector may be formed by forming a metal material, such as copper, copper alloy, nickel, nickel alloy, titanium, titanium alloy, silver, or silver alloy on a polymer substrate such as polypropylene (PP), polyethylene terephthalate (PET), polybutylene terephthalate (PBT), polystyrene (PS), or polyethylene (PE).

A preparation method of the negative electrode film layer in these embodiments of the present application includes mixing raw materials at a specific mass ratio with a solvent to form a negative electrode slurry, defoaming the negative electrode slurry, and uniformly applying the negative electrode slurry on one or both surfaces of the negative current collector, followed by drying to obtain a negative electrode plate including the negative electrode film layer.

### Separator

In some embodiments, the secondary battery further includes a separator. The present application imposes no particular limitation on the type of the separator, and any well-known porous structure separator having good chemical stability and mechanical stability may be selected.

In some embodiments, the separator includes a base material layer and a coating provided on a surface of the base material layer; a base material of the base material layer includes one or more of polyethylene, polypropylene, poly(p-phenylene terephthalate, polytetrafluoroethylene, terephthalamide), polyethylene polyacrylonitrile, polyimide, and polyamide; and the coating includes a ceramic coating and/or a polymer coating. The base material layer has good permeability to lithium ions, which is conducive to the migration of lithium ions. The surface of the base material layer is provided with the coating, and the coating can further improve the mechanical properties of the separator. Optionally, the ceramic particles in the ceramic coating include one or more of SiO₂, Al₂O₃, AlOOH, CaO, TiO₂, MgO, ZnO, ZrO₂, Mg(OH)₂, and BaSO₄. Optionally, a polymer material of the polymer coating includes one or more of polyethylene (PE), polypropylene (PP), poly(p-phenylene terephthalamide) (PPTA), polyethylene terephthalate (PET), polytetrafluoroethylene (PTFE), polyacrylonitrile (PAN), polyimide (PI), and polyamide (PA). The polymer coating and the base material layer may be made of the same material or different materials, and the polymer coating and the base material layer may be different in thickness. Optionally, the thickness of the polymer coating is less than the thickness of the base material layer.

In some other embodiments, the material of the separator may be selected from at least one of glass fiber, non-woven fabric, polyethylene, polypropylene, and polyvinylidene fluoride. The separator may be a single-layer film or a multi-layer composite film, which is not particularly limited. When the separator is a multi-layer composite film, the materials of the layers may be the same or different, which are not particularly limited.

### EXAMPLES

The following examples are used to more specifically describe the content disclosed in the present application. These examples are for illustrative purposes only, as various modifications and changes within the scope of the disclosure of the present application are obvious to those skilled in the art. Unless otherwise stated, all parts, percentages, and ratios reported in the following examples are based on mass, and all reagents used in the examples are commercially available or synthesized according to conventional methods and may be used directly without further treatment, and the instruments used in the examples are all commercially available.

### Example 1

Lithium iron manganese phosphate was selected, where the chemical formula of the lithium iron manganese phosphate was LiFe_{0.5}Mn_{0.5}PO₄, and a volumetric particle size distribution of the lithium iron manganese phosphate was shown in Table 1; and the lithium iron manganese phosphate raw material was baked in an oven at 110° C. for 12 h.

### 1. Preparation of Positive Electrode Plate:

The above-treated lithium iron manganese phosphate (Dv50 was 1 μm), a positive electrode conductive agent carbon black, and a positive electrode binder polyvinylidene fluoride (PVDF) were dispersed in an appropriate amount of solvent NMP at a ratio of 98:0.9:1.1 and fully stirred and mixed to form a uniform positive electrode slurry; the positive electrode slurry was applied on both surfaces of the positive electrode current collector, heated and dried, specifically using a multi-section oven with temperatures set sequentially at 120° C./100° C./90° C.; and then a cold press was used for compaction to obtain a positive electrode plate with a compacted density of 2.7 g/cm³, and a single-sided coating weight of the positive electrode plate was 0.40 g/1540.25 mm². The particle size distribution of the positive electrode active material lithium iron manganese phosphate, the coating weight and compacted density of the positive electrode plate, and other related performance parameters are shown in Table 1.

### 2. Preparation of Electrolyte:

In an environment with a water content less than 10 ppm, non-aqueous organic solvents ethylene carbonate and diethyl carbonate were mixed at a volume ratio of 1:1 to obtain a first solvent; ethyl acetate and propyl acetate were mixed at a volume ratio of 2:1 to obtain a second solvent; the first solvent and the second solvent were mixed according to specific use amounts to form a non-aqueous solvent; a first lithium salt lithium hexafluorophosphate and a second lithium salt lithium bis(fluorosulfonyl)imide and/or lithium bis(trifluoromethanesulfonyl)imide was added to the non-aqueous solvent; and then a film-forming stabilizer (lithium fluorosulfonate and/or lithium difluorophosphate) was added to form an electrolyte. The percentage of each component in the electrolyte is shown in Table 2.

### 3. Preparation of Negative Electrode Plate:

A negative electrode active material artificial graphite, a binder styrene-butadiene rubber (SBR), a thickener sodium carboxymethyl cellulose (CMC-Na), and a conductive agent carbon black (Super P) were fully stirred and mixed in an appropriate amount of solvent deionized water at a weight ratio of 96.2:1.8:1.2:0.8 to form a uniform negative electrode slurry, and the negative electrode slurry was uniformly applied on a surface of the negative current collector copper foil, followed by drying and cold pressing to obtain a negative electrode plate. A single-sided coating weight of the negative electrode plate was 0.18 g/1540.25 mm², and the coating weight and other related performance parameters of the negative electrode plate are shown in Table 1.

### 4. Separator:

A porous polyethylene (PE) film was used as the separator.

### 5. Preparation of Secondary Battery:

The above positive electrode plate, separator, and negative electrode plate were stacked in order, with the separator positioned between the positive electrode plate and the negative electrode plate for isolation, and then wound to obtain an electrode assembly; the electrode assembly was placed in an outer packaging housing and dried; and an electrolyte was injected, followed by processes such as vacuum sealing, standing, formation, and shaping to obtain a lithium-ion battery.

### Example 2

A secondary battery was provided, and the particle size of the positive electrode active material and the related parameters and performance of the electrolyte of the secondary battery were different from those of Example 1. Specifically, the specific parameters and performance of Examples 2-1 and 2-5 were different, as shown in Tables 1 and 2.

### Example 3

A secondary battery was provided, and the coating weight and compacted density of the positive electrode plate, the coating weight of the negative electrode plate, and the related parameters and performance of the electrolyte of the secondary battery were different from those of Example 1. Specifically, those of Examples 3-1 to 3-3 were different, as shown in Tables 1 and 2.

### Example 4

A secondary battery was provided, and the percentage of the positive electrode active material, the coating weight and compacted density of the positive electrode plate, the coating weight of the negative electrode plate, and the related parameters and performance of the electrolyte of the secondary battery were different from those of Example 1. Specifically, those of Examples 4-1 and 4-2 were different, as shown in Tables 1 and 2.

### Example 5

A secondary battery was provided, and the type of the positive electrode active material, and the coating weight and compacted density of the positive electrode plate of the secondary battery were different from those of Example 1. Specifically, those of Examples 5-1 and 5-2 were different, where the chemical formula of the lithium iron phosphate used in Example 5-1 was LiFePO₄, and the chemical formula of the lithium manganese phosphate used in Example 5-2 was LiMnPO₄, as shown in Tables 1 and 2.

TABLE 1
Parameter list of positive electrode plate and negative electrode plate

| | | | | | | | | Negative |
|---|---|---|---|---|---|---|---|---|
| | | | | | | | | electrode |
| | | | | | | | | plate |
| | | | | | | Positive electrode plate | | Single- |
| | | | | | | Single-sided | | sided |
| | | | | | | coating | | coating |
| | Positive electrode active material | | | | | weight | Compacted | weight |
| | | Percentage | Particle size (μm) | | | (g/1540.25 | density | (g/1540.25 |
| | Type | (%) | Dv50 | Dv90 | Dv10 | mm²) | (g/cm³) | mm²) |
| Example 1 | Lithium | 98% | 1 | 5 | 0.2 | 0.4 | 2.7 | 0.18 |
| Example 2- | iron | 98% | 2 | 10 | 0.9 | 0.4 | 2.7 | 0.18 |
| 1 | manganese | | | | | | | |
| Example 2- | phosphate | 98% | 1.8 | 15 | 0.45 | 0.4 | 2.7 | 0.18 |
| 2 | | | | | | | | |
| Example 2- | | 98% | 0.5 | 3.8 | 0.2 | 0.4 | 2.7 | 0.18 |
| 3 | | | | | | | | |
| Example 2- | | 98% | 0.35 | 3.5 | 0.2 | 0.4 | 2.7 | 0.18 |
| 4 | | | | | | | | |
| Example 2- | | 98% | 0.3 | 3 | 0.1 | 0.4 | 2.7 | 0.18 |
| 5 | | | | | | | | |
| Example 3- | | 98% | 1 | 5 | 0.2 | 0.5 | 2.62 | 0.25 |
| 1 | | | | | | | | |
| Example 3- | | 98% | 1 | 5 | 0.2 | 0.3 | 2.55 | 0.15 |
| 2 | | | | | | | | |
| Example 3- | | 98% | 1 | 5 | 0.2 | 0.25 | 2.46 | 0.13 |
| 3 | | | | | | | | |
| Example 4- | | 90% | 1 | 5 | 0.2 | 0.25 | 2.48 | 0.13 |
| 1 | | | | | | | | |
| Example 4- | | 95% | 1 | 5 | 0.2 | 0.4 | 2.6 | 0.18 |
| 2 | | | | | | | | |
| Example 5- | Lithium | 98% | 1 | 5 | 0.2 | 0.4 | 2.68 | 0.18 |
| 1 | iron | | | | | | | |
| | phosphate | | | | | | | |
| Example 5- | Lithium | 98% | 1 | 5 | 0.2 | 0.4 | 2.69 | 0.18 |
| 2 | manganese | | | | | | | |
| | phosphate | | | | | | | |

TABLE 2
Parameter list of electrolyte

| | First lithium | | Second lithium | | | Film-forming | | | | | |
|---|---|---|---|---|---|---|---|---|---|---|---|
| | salt | | salt | | | stabilizer | | Carboxylate | | Carbonate | |
| | | Per- | | Per- | | | Per- | | Per- | | Per- |
| | | centage | | centage | | | centage | | centage | | centage |
| | Type | a (%) | Type | b (%) | a/b | Type | (%) | Type | (%) | Type | (%) |
| Example | Lithium | 8% | LiFSI + | 8% | 1 | Lithium | 0.6% + | Ethyl | 60% | Ethylene | 22.5% |
| 1 | hexafluorophosphate | | LiTFSI | | | fluorosulfonate + | 0.9% | acetate + | | carbonate + | |
| | | | | | | lithium | | propyl | | diethyl | |
| | | | | | | difluorophosphate | | acetate | | carbonate | |
| Example | | 2% | LiFSI | 8% | 0.25 | Lithium | 0.02% | Ethyl | 70% | | 19.98% |
| 2-1 | | | | | | fluorosulfonate | | acetate + | | | |
| | | | | | | | | propyl | | | |
| | | | | | | | | acetate | | | |
| Example | | 4% | LiFSI + | 8% | 0.5 | Lithium | 0.6% + | Ethyl | 70% | | 16.5% |
| 2-2 | | | LiTFSI | | | fluorosulfonate + | 0.9% | acetate | | | |
| | | | | | | lithium | | | | | |
| | | | | | | difluorophosphate | | | | | |
| Example | | 10% | LiTFSI | 5% | 2 | Lithium | 2% | Propyl | 70% | | 13% |
| 2-3 | | | | | | difluorophosphate | | acetate | | | |
| Example | | 10% | LiFSI + | 2.5% | 4 | Lithium | 0.6% + | Ethyl | 70% | | 16% |
| 2-4 | | | LiTFSI | | | fluorosulfonate + | 0.9% | propionate | | | |
| | | | | | | lithium | | | | | |
| Example | | 10% | | 1.4% | 7 | difluorophosphate | 0.6% + | Methyl | 70% | | 17.1% |
| 2-5 | | | | | | | 0.9% | propionate | | | |
| Example | | 8% | | 8% | 1 | | 0.2% + | Ethyl | 60% | | 22.9% |
| 3-1 | | | | | | | 0.9% | acetate + | | | |
| Example | | 8% | | 8% | 1 | | 0.8% + | propyl | 60% | | 22.3% |
| 3-2 | | | | | | | 0.9% | acetate | | | |
| Example | | 8% | | 8% | 1 | | 1% + | | 60% | | 22.1% |
| 3-3 | | | | | | | 0.9% | | | | |
| Example | | 8% | | 8% | 1 | | 0.6% + | | 5% | | 77.5% |
| 4-1 | | | | | | | 0.9% | | | | |
| Example | | 8% | | 8% | 1 | | 0.6% + | | 30% | | 52.5% |
| 4-2 | | | | | | | 0.9% | | | | |
| Example | | 8% | | 8% | 1 | | 0.6% + | | 60% | | 22.5% |
| 5-1 | | | | | | | 0.9% | | | | |
| Example | | 8% | | 8% | 1 | | 0.6% + | | 60% | | 22.5% |
| 5-2 | | | | | | | 0.9% | | | | |

### Comparative Example 1

Differed from Example 1 in that:

Lithium iron phosphate particles with a conventional particle size in the art were used as the positive electrode active material, with Dv50 of 5.0 μm, Dv10 of 1.0 μm, and almost no submicron-scale particles. The water content or hygroscopicity of particles at this level was significantly higher than that of the present application.

The electrolyte included lithium hexafluorophosphate with a mass percentage of 16%, and ethylene carbonate+diethyl carbonate were used as the solvent.

Others were the same as in Example 1.

### Comparative Example 2

Differed from Example 1 in that:

Lithium iron phosphate particles with a conventional particle size in the art were used as the positive electrode active material, with Dv50 of 5.0 μm, Dv10 of 1.0 μm, and almost no submicron-scale particles.

Others were the same as in Example 1.

### Comparative Example 3

Differed from Example 1 in that:

The electrolyte included no film-forming stabilizer, and the amount of carbonate was increased to compensate for the absence of the film-forming stabilizer.

### Comparative Example 4

Differed from Example 1 in that:

The electrolyte included no second lithium salt, and the amount of carbonate was increased to compensate for the absence of the second lithium salt.

The related parameters of Comparative Examples 1 to 4 are specifically shown in Tables 1 and 2, and the performance of the battery is shown in Table 3.

### [Testing of Related Parameters]

1. Particle size test: With reference to the standard GB/T19077-2016: a volumetric particle size distribution curve of the lithium-containing transition metal phosphate was obtained, a particle size corresponding to the cumulative volume distribution percentage reaching 50% was taken as the average particle size Dv50, a particle size corresponding to the cumulative volume distribution percentage reaching 90% was taken as the average particle size Dv90, and a particle size corresponding to the cumulative volume distribution percentage reaching 10% was taken as the average particle size Dv10. The test instrument might be the Mastersizer 3000 laser particle size analyzer from Malvern Instruments Ltd., UK.

### Volumetric Average Particle Size Dv50 Test:

Reference is made to the standard GB/T 19077-2016/ISO 13320:2009 particle size distribution laser diffraction method. A laser particle size analyzer (Malvern 3000, MasterSizer 3000) was used for testing, with a helium-neon red light source serving as a main light source. 1 g of a sample to be tested was added to a clean small beaker, 20 mL deionized water was added (a concentration of the sample ensured that the shading degree was 8% to 12%), and one drop of surfactant was added to reduce the surface tension of water to facilitate the wetting of particles, and ultrasonic treatment was performed at 53 KHz/120 W for 5 min to ensure complete dispersion of the sample. The laser particle size analyzer was turned on, and after an optical path system was cleaned, and the background was automatically tested. The ultrasonically treated solution to be tested was stirred to make it uniformly dispersed, placed in a sample tank as required, and then particle size measurement was started. Measurement results could be read from the instrument.

### 2. Test of Compacted Density of Positive Electrode Plate:

The compacted density of the positive electrode plate may be measured by a method commonly used in the art. As an example, the areal density might be tested first, and then the compacted density was obtained according to compacted density=areal density/thickness.

First, a positive electrode plate with a unit area was taken and its mass was weighed as m1, then a mass m2 of the positive electrode foil with a unit area was weighed, then a mass of the positive electrode film layer was obtained by subtracting m2 from m1, and then the result was divided by an area of the positive electrode film layer to obtain the areal density.

### [Battery Performance Tests]

### 3. Energy Density Test:

At 25° C., the battery was charged at a constant current of 0.33 C and a constant voltage to a designed upper limit voltage of 3.75 V and a cut-off current of 0.05 C, left standing for 30 min, and then discharged at 0.33 C to a designed lower limit voltage of 2.5 V; a discharge energy P (Wh) was recorded; and a cell weight was recorded as m (kg), where energy density (Wh/kg)=P/m.

### 4. Fast Charging Capability Test:

The batteries of the above examples and comparative examples were charged and discharged for the first time with a current of 1 C (that was, a current value enabling the theoretical capacity to be discharged completely within 1 h), specifically including that: at 35° C., the battery was charged at a constant current rate of 1 C to a voltage of 4.4 V, then charged at a constant voltage to a current less than or equal to 0.05 C, left standing for 5 min, and then discharged at a constant current rate of 0.33 C to a voltage of 2.8 V; and an actual capacity was recorded as C0. Then, the battery was sequentially charged at constant currents of 1.0 C0, 1.3 C0, 1.5 C0, 1.8 C0, 2.0 C0, 2.3 C0, 2.5 C0, 3.0 C0, 3.5 C0, 4C0, 4.5 C0, and 5C0 to a full battery charge cut-off voltage of 4.4 V or a negative electrode cut-off potential of 0 V (based on the one reached first); after each charging was completed, the battery needed to be discharged at 1C0 to a full battery discharge cut-off voltage of 2.8 V; negative electrode potentials after the battery was charged to states of charge of 10% SOC, 20% SOC, 30% SOC, . . . , and 80% SOC (State of Charge, state of charge, “SOC=0” indicated that the battery was completely discharged, and “SOC=100%” indicated that the battery was fully charged) under different charging rates was recorded; a charging rate-negative electrode potential curve under different SOCs was drawn, followed by linear fitting to obtain charging rates corresponding to the negative electrode potential of 0 V under different SOC states, which were charging windows under those SOCs, recorded as C10% SOC, C20% SOC, C30% SOC, C40% SOC, C50% SOC, C60% SOC, C70% SOC, C80% SOC, respectively; and a charging time T for charging the battery from 10% SOC to 80% SOC was calculated according to the formula (60/C20% SOC+60/C30% SOC+60/C40% SOC+60/C50% SOC+60/C60% SOC+60/C70% SOC+60/C80% SOC)×10%, measured in min. A shorter time indicates better fast charging performance of the battery.

### 5. Cycling Performance Test:

At 45° C., the secondary batteries prepared in the examples and comparative examples were charged at a constant current of 1 C (that was, a current value enabling the theoretical capacity to be completely discharged within 1 h) to 3.75 V, then charged at a constant voltage of 3.75 V to a current of 0.05 C, left standing for 5 min, then discharged at a constant current of 1 C to 2.5 V, and left standing for 30 min. This was one charge-discharge cycle, and a battery capacity at this time was recorded as C0. Each battery was subjected to n cycles of charge and discharge according to this method, and the battery capacity after n cycles was recorded as C1, where cycling capacity retention rate of battery at 25° C.=C1/C0× 100%. The number of cycles n corresponding to the measured cycling capacity retention rate of 80% of the battery was recorded.

TABLE 3
Performance list of batteries

| | Energy density | Fast charging | Cycles at 80% |
|---|---|---|---|
| | (Wh/kg) | performance (min) | capacity |
| Example 1 | 200 | 25 | 4201 |
| Example 2-1 | 193.5 | 31 | 3669 |
| Example 2-2 | 193.4 | 26 | 4092 |
| Example 2-3 | 194 | 29 | 4021 |
| Example 2-4 | 205 | 25.5 | 4133 |
| Example 2-5 | 205.5 | 25.2 | 3964 |
| Example 3-1 | 191 | 28.5 | 3672 |
| Example 3-2 | 195.5 | 20.2 | 4191 |
| Example 3-3 | 195.5 | 15.2 | 4214 |
| Example 4-1 | 190.4 | 36 | 3521 |
| Example 4-2 | 194 | 26.8 | 3609 |
| Example 5-1 | 190 | 24.8 | 4021 |
| Example 5-2 | 191 | 25.2 | 4009 |
| Comparative | 180.5 | 47.5 | 2811 |
| Example 1 | | | |
| Comparative | 180.5 | 37 | 3483 |
| Example 2 | | | |
| Comparative | 200.5 | 35.2 | 3322 |
| Example 3 | | | |
| Comparative | 200.5 | 36.3 | 3113 |
| Example 4 | | | |

From the comparison between the effect data of Examples 1 to 5 and the effect data of Comparative Examples 1 to 4, it is found that the method designed in the present application is conducive to balancing the energy density, fast charging performance, and cycling performance of the battery. In both Comparative Examples 1 and 2 of the present application, positive electrode active materials without submicron-scale particles are used, and the energy density of the formed batteries are greatly reduced. With further reference to Example 1 and Comparative Example 2, as well as Comparative Example 1 and Comparative Example 2, it can be seen that the particle size of the positive electrode active material has a greater impact on the energy density and fast charging performance of the battery. A larger particle size results in lower energy density and longer fast charging time.

From the comparison between Comparative Example 1 and Comparative Example 2 and the comparison between Example 1 and Comparative Example 4, the presence of the second lithium salt can effectively improve the fast charging performance of the battery. The comparison between Comparative Example 1 and Comparative Example 3, and the comparison between Example 1 and Comparative Example 3 show that the film-forming stabilizer can effectively improve the cycling performance of the battery.

In conclusion, it should be noted that the above examples are only used to illustrate the technical solutions of the present application rather than to limit them. Although the present application has been described in detail with reference to the foregoing embodiments, those of ordinary skill in the art should understand that they can still modify the technical solutions recorded in the foregoing embodiments or equivalently replace some or all of the technical features; and these modifications or replacements do not make the essence of the corresponding technical solutions depart from the scope of the technical solutions of the embodiments of the present application, which should all be covered within the scope of the claims and specification of the present application. In particular, as long as there is no structural conflict, the technical features mentioned in the embodiments can be combined in any manner. The present application is not limited to the specific embodiments disclosed herein, but includes all technical solutions falling within the scope of the claims.

1. A secondary battery, comprising:
a positive electrode plate: comprising a lithium-containing transition metal phosphate, wherein the lithium-containing transition metal phosphate comprises submicron-scale and micron-scale particles;
a negative electrode plate; and
an electrolyte: comprising a lithium salt and a film-forming stabilizer, wherein the lithium salt comprises a first lithium salt and a second lithium salt; wherein
the first lithium salt comprises lithium hexafluorophosphate, and the second lithium salt comprises one or both of lithium bis(fluorosulfonyl)imide and lithium bis(trifluoromethanesulfonyl)imide.

2. The secondary battery according to claim 1, wherein that the lithium-containing transition metal phosphate satisfies one or both of the following:
a volumetric particle size distribution of the lithium-containing transition metal phosphate satisfies: Dv50 is 0.3 μm to 2.0 μm, 3.0 μm≤Dv90≤20 μm, and 0.1 μm≤Dv10≤1 μm; and
the lithium-containing transition metal phosphate comprises one, two, or more of lithium iron phosphate, lithium manganese phosphate, and lithium iron manganese phosphate.

3. The secondary battery according to claim 1, wherein Dv50 of the lithium-containing transition metal phosphate is 0.35 μm to 1.8 μm.

4. The secondary battery according to claim 1, wherein that the positive electrode plate satisfies one, two, or more of the following:
a single-sided coating weight of the positive electrode plate is 0.25 g/1540.25 mm² to 0.50 g/1540.25 mm²;
a mass percentage of the lithium-containing transition metal phosphate in the positive electrode plate is 90% to 98%; and
a compacted density of the positive electrode plate is 2.4 g/cm³ to 2.7 g/cm³.

5. The secondary battery according to claim 1, wherein that the lithium salt satisfies one, two, or more of the following:
a mass percentage of the first lithium salt is a, a mass percentage of the second lithium salt is b, and 0.2<a/b≤7;
2%≤a≤15%; and
0.2%≤b≤8%.

6. The secondary battery according to claim 1, wherein that the lithium salt satisfies the following conditions:
a mass percentage of the first lithium salt is a, and 4%≤a≤10%;
and/or
a mass percentage of the second lithium salt is b, and 0.8%≤b≤6%.

7. The secondary battery according to claim 1, wherein that the film-forming stabilizer satisfies one or both of the following:
the film-forming stabilizer comprises one or both of lithium fluorosulfonate and lithium difluorophosphate; and
based on a total mass of the electrolyte, a mass percentage of the film-forming stabilizer is 0.02% to 2%.

8. The secondary battery according to claim 1, wherein that based on a total mass of the electrolyte, a mass percentage of the film-forming stabilizer is 0.1% to 1.5%.

9. The secondary battery according to claim 1, wherein that the film-forming stabilizer comprises lithium fluorosulfonate and lithium difluorophosphate, and based on a total mass of the electrolyte, a mass percentage of lithium difluorophosphate is less than or equal to 1%, and a mass percentage of lithium fluorosulfonate is greater than or equal to 0.2% and less than 2%.

10. The secondary battery according to claim 1, wherein that the electrolyte comprises a solvent, the solvent comprises a carboxylate, and the carboxylate satisfies one or both of the following:
the carboxylate has the following structural formula:
R1—COO—R2;
wherein R1 and R2 each independently comprise a substituted and/or unsubstituted C1-C5 alkyl; and
based on a mass of the electrolyte, a mass percentage of the carboxylate is 5% to 70%.

11. The secondary battery according to claim 1, wherein that the electrolyte comprises a solvent, the solvent comprises a carboxylate, and the carboxylate satisfies one or both of the following:
the carboxylate comprises one or more of ethyl acetate, methyl acetate, ethyl propionate, propyl acetate, methyl propionate, and methyl butyrate; and
based on a mass of the electrolyte, a mass percentage of the carboxylate is 10% to 60%.

12. The secondary battery according to claim 1, wherein that the electrolyte comprises a solvent, the solvent comprises a carboxylate and a carbonate, and the carbonate satisfies one or both of the following:
based on a mass of the electrolyte, a mass percentage of the carbonate is greater than or equal to 5%; and
the carbonate comprises one, two, or more of ethylene carbonate, propylene carbonate, fluoroethylene carbonate, vinylene carbonate, dimethyl carbonate, diethyl carbonate, and ethyl methyl carbonate.

13. The secondary battery according to claim 1, wherein that the negative electrode plate satisfies one or both of the following:
(8.1) a single-sided coating weight of the negative electrode plate is 0.13 g/1540.25 mm² to 0.25 g/1540.25 mm²; and
(8.2) the negative electrode plate comprises a carbon material.

14. An electric apparatus, comprising the secondary battery according to claim 1.
